(19) United States
(12) Patent Application Publication
(10) Pub. No.: US 2012/0069581 A1
(43) Pub. Date: Mar. 22, 2012

(54) OUTDOOR LIGHT HAVING TRANSLUCENT MOSAIC LENS

(76) Inventor: Chi Gon CHEN, Guang Zhou (CN)

(21) Appl. No.: 12/888,288

(22) Filed: Sep. 22, 2010

(51) Int. Cl. F21V 5/00; B29D 11/00; F21V 5/04

(52) U.S. Cl. 362/311.14; 156/299

(57) ABSTRACT

An outdoor lighting fixture having a composite lens assembly that includes a transparent liner or sleeve having a translucent mosaic covering composed of a plurality of glass shards having a grout compound infused in the interstices between the plurality of glass shards. The transparent liner is a thin-walled cup having a shape that is symmetrical about its vertical axis and is open at its upper end. The transparent liner may have a frusto-conical, cylindrical, parabolic, hemi-spherical shape or any combination thereof. While the liner or sleeve is preferably transparent, other embodiments may be colored or frosted translucent to provide differing illumination effects. In addition, while the exterior and interior surfaces of the transparent liner are preferably smooth, in other embodiments they may be textured. A novel two-step process for manufacturing the composite lens assembly is also disclosed.

### BACKGROUND OF THE INVENTION

1. Technical Field of the Invention

The present invention pertains to lighting systems such as those primarily in close proximity to residences for the purpose of illuminating walkways or providing decorative lighting; more particularly the present invention pertains to an outdoor light having a translucent mosaic lens.

2. Description of the Related Art

Outdoor lighting provides a number of practical and aesthetic benefits for buildings and homes and for garden areas including lawns, walkways, and pool facilities. Among the practical benefits are safety for walking and security, by the lighting of dark spots and shadows around buildings and homes and lighting walkways, steps, and obstacles.

Outdoor lighting also provides important aesthetic benefits. These include making visible the beauty and charm of a home after dark. Features, such as walkways, of a home's exterior may be highlighted and landscape areas may be accented.

A variety of lighting systems have been previously developed to power outdoor lighting systems. For example, standard voltage (i.e., 120 volts AC) and low-voltage (e.g., 12 DC) powered systems have been long practiced. Low voltage lighting systems are generally safer than high voltage systems, in that wiring for low voltage systems can be placed on the ground, preferably buried at shallow depths, or looped through shrubbery and trees, while in contrast, high voltage systems require closed conduits and often require technical expertise to design and install.

More recently, solar powered outdoor lighting systems have become quite popular and prevalent. In the past several years, the technology associated with solar panels and light emitting diodes (LEDs) has seen rapid development. Specifically, while solar panels were once almost a novelty item or an item used only in remote locations, both the cost of solar panels has decreased and the output of electrical energy from solar panels has increased. Similarly, while light emitting diodes had only limited applications for many years, both the cost of light emitting diodes has decreased and the output of light energy has increased. Accordingly, the power available from solar panels has grown to a level where the power requirements for a light emitting diode having an acceptable light output level for use in an outdoor setting can now be met with a solar panel. Similarly, the cost of both solar panels and light emitting diodes have both decreased to the point where an outdoor light fixture using electrical energy obtained from solar panels and emitting light from light emitting diodes is affordable to most homeowners.

The convergence of the development of the technology associated with solar panels and the technology associated with light emitting diodes has created a market where small solar-powered outdoor lighting fixtures used to mark walkways or to enhance the appearance of landscaping are now in great demand by homeowners.

A common variant of such outdoor solar-powered light fixtures includes a body having a spike that is driven into a ground surface. At the upper end of the spike, a diffuser lens assembly is mounted that encompasses a chamber, which surrounds a light emitting device, such as one or more LEDs. The light emitting devices extend from the bottom of a cap assembly, which is attached to the open, upper end of the diffuser lens. The cap assembly typically includes a solar panel, battery assembly and electrical componentry. The solar panel captures light energy and turns it into electrical energy. The electrical energy is then stored in a battery and then directed, when needed, to the light emitting device which illuminates on receipt of the electrical energy obtained from the battery.

To enhance its commercial and decorative value, the structure of such outdoor light fixtures is often made to be as attractive as possible. Previously, a wide variety of proposals have been made that enhance the aesthetic qualities of such outdoor light fixtures. Numerous ornamental designs have been created featuring diffuser lens assemblies of various graceful shapes. Nonetheless, a continuing need exists for developing innovative methods and designs to further enhance the aesthetic qualities of such outdoor light fixtures.

In the past, certain lighting devices have employed light shades made of a fine mosaic of stained glass patterned portions separated from one another by leaded portions, typically known “Tiffany” glass lamp shades. The light emanating from a lighting device with a Tiffany-style lamp shade is diffused and multi-colored, creating a warm and attractive glow. However, traditional methods for fabricating Tiffany-style stained glass lamp shades are both cost and time prohibitive when applied to the manufacture of outdoor light fixtures.

For example, one traditional method for fabricating Tiffany lamp shades includes providing a wooden form conforming to the shape of the lamp shade. A thin paper or linen is then adhesively attached to the form, conforming to the curved surface of the form, and the artist then makes a line drawing of the desired design. The lines of the drawing defined a multiplicity of areas of different sizes and shapes in which correspondingly sized and shaped pieces of stained glass are to occupy in the completed design.

The paper or linen is then stripped off the form, cut apart along enough of the pattern lines to lie flat, and the various areas are numbered. A copy is made by tracing and is then reproduced and copies used for reference purposes. The original copy is cut into patterns to be used in cutting different colored pieces of stained glass into corresponding shapes and sizes. The surface of the form is then coated with an appropriate pressure-sensitive adhesive wax, and the glass pieces are then adhesively attached to the surface of the form using the copy of the drawing as a reference.

The stained glass pieces are then independently removed from the form, framed with adhesive-backed copper foil, and then replaced. The pieces are then soldered together using the copper foil as a base for the solder. The form is then heated to a temperature sufficient to melt the adhesive wax so as to permit the resulting lamp shade to be lifted off the form. The soldering process is then repeated for the interior of the lamp shade. Upper and lower metal rims are then soldered to the assembly. The lamp shade may then be finished by electroplating copper over the solder surfaces, and by patinating the resulting copper surfaces.

Thus, a major drawback to traditional methods for fabricating Tiffany-styled stained glass lamp shades when applied to the manufacture of outdoor light fixtures is the high cost of production caused by the need for highly skilled labor and the substantial time required to produce the stained glass objects. Moreover, such elegant, traditionally manufactured Tiffany-style stained glass lamp shades are usually heavy, difficult to handle, susceptible to damage, and problematic to repair. These problems are only compounded when one considers the reduced dimensions of typical outdoor light fixtures. In addition, Tiffany-styled stained glass lamp shades and diffuser lens assemblies resulting from traditional manufacturing methods are not readily or easily interchangeable with current mass produced lamp shades and diffuser lens assemblies.

Therefore, it is an objective of the present invention to provide an improved outdoor light fixture having a Tiffany-style stained glass diffuser lens assembly that is efficient and economical to manufacture. It is a further object of the present invention to provide an improved method for making Tiffany-style stained glass lamp shades and diffuser lens assemblies as compared with the traditional method described above.

### SUMMARY OF THE INVENTION

An outdoor lighting fixture having a composite lens assembly that includes a transparent liner or sleeve having a translucent mosaic covering composed of a plurality of glass shards having a grout compound infused in the interstices between the plurality of glass shards. The transparent liner or sleeve is preferably constructed of a polymer (such as plastics or the like) or silica glass that is capable of transmitting light yet protecting the lighting components from the elements. The transparent liner is a thin-walled cup having a shape that is symmetrical about its vertical axis and is open at one end. The shape of the transparent liner may include frusto-conical, cylindrical, parabolic, hemi-spherical shape or any combination thereof. While the liner or sleeve is preferably transparent, other embodiments may be colored or frosted translucent to provide differing illumination effects. In addition, while the exterior and interior surfaces of the transparent liner are preferably smooth, in other embodiments they may be textured.

A novel feature of the invention is an annular lip portion, which extends outwardly from the circumferential rim of the transparent liner. The annular lip provides an abutment against which the glass shards can be accurately and efficiently positioned. The annular lip portion may further include a coupling mechanism for attaching the top rim of the transparent liner to a cap assembly.

The composite lens assembly is manufactured in a two-step process. First, a plurality of individual glass shards are adhered to the outer or exterior surface of the transparent liner. The glass shards are preferably comprised of colored silica glass arranged in a decorative pattern. The individual glass shards may be geometrically or irregularly shaped. An adhesive substance (preferably silicon based adhesive) is applied to a surface of each glass shard, which is then brought into contact with the exterior surface of the transparent liner forming an adhesive bond.

Once the exterior surface of the transparent liner is sufficiently covered with the plurality of glass shards, a cementious grout compound is infused into the interstices between the plurality of glass shards. A heavy layer of the grout compound is applied to the surface of the liner covered with the plurality of glass shards. The grout compound is then worked into the interstices between the plurality of glass shards until the interstices are filled with grout compound approximately up to the level of the glass shards. The grout compound is then allowed to set or firm-up whereupon the exterior of the composite lens assembly is wiped down with a cloth removing any grout residue from the plurality of glass shards revealing a tiffany-style lens assembly.

In a preferred embodiment, the composite lens assembly of the present invention is configured as a “garden light” having a body comprising an extender assembly or post on the lower end from which there extends a spike, which is designed to be driven into a ground surface so that the post is exposed above the ground surface. The bottom of the composite lens assembly is attached to the upper end of the post. The top or circumferential rim of the composite lens assembly is attached to a cap assembly, which houses the power and control assemblies. The transparent liner may include means for rotatively attaching or coupling the composite lens assembly to the cap assembly.

In another embodiment, the composite lens assembly of the present invention is configured as a hanging solar powered decorative light having a composite lens assembly attached to a cap assembly that includes a hanging mechanism.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 is a perspective view of an embodiment of the light fixture of the present invention, featuring a partial close-up view of the Tiffany-styled stain glass portion thereof;

FIG. 2A is an exploded perspective view thereof;

FIG. 2B is a cross-sectional view of the top portion thereof;

FIG. 3A is a perspective view of a second embodiment of the light fixture of the present invention;

FIG. 3B is an exploded perspective view thereof;

FIG. 3C is a close-up perspective view of the top of the cylindrical diffuser lens assembly of the embodiment of the light fixture of the present invention shown in FIG. 3A;

FIG. 4 is an elevation view of a third embodiment of the light fixture of the present invention;

FIG. 5 is an perspective view of a fourth embodiment of the light fixture of the present invention; and

FIG. 6 is a perspective view of a fifth embodiment of the light fixture of the present invention.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

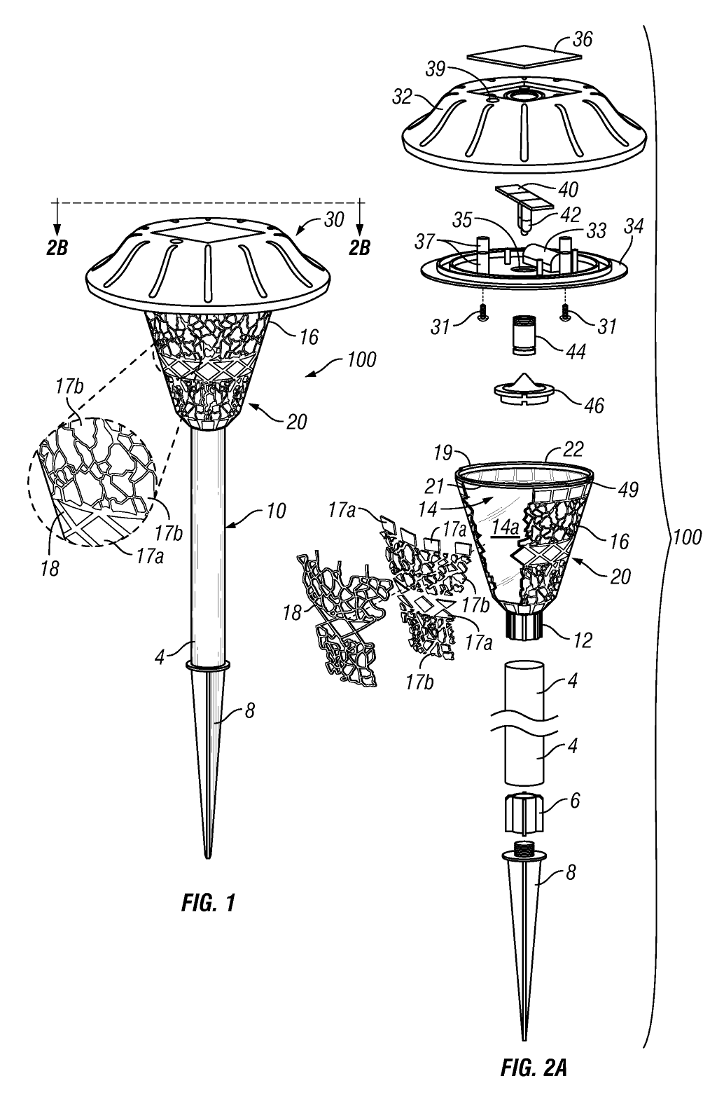

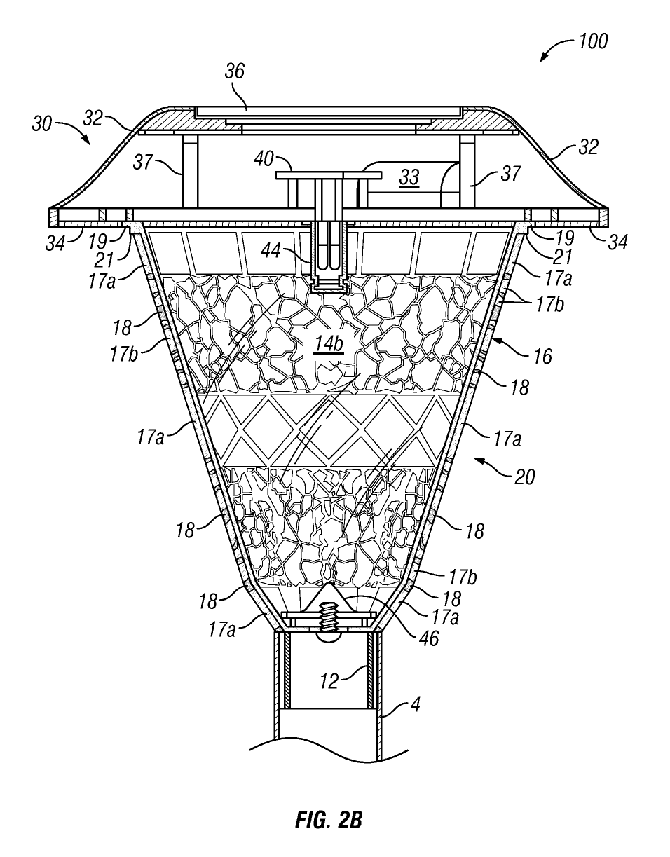

FIGS. 1, 2A and 2B depict a first embodiment of the present invention 100. This embodiment 100 is a solar powered outdoor lighting fixture that can be located and operated in any area that receives daytime exposure to sunlight. As depicted, the light fixture 100 of this embodiment is configured as a “garden light”. The light fixture 100 includes a body 10 comprising an extender assembly or post 4 on the lower end from which there extends a spike 8. The spike 8 is connected to the post 4 by means of a friction fit connector 6. The spike 8 is driven into a ground surface so that the post 4 is exposed above the ground surface.

The post 4 in this embodiment is a rigid cylindrical tubular shaft constructed from machined or extruded aluminum. Aluminum is chosen to reduce corrosion and cost and to create a sturdy yet aesthetically pleasing support. However, one skilled in the art will appreciate that the post 4 may also be manufactured using polymers (such as plastics or the like) or other metals (such as mild steel or the like). Moreover, although the shape is cylindrical, the shaft may be extruded or machined into other shapes (such as a pentagon or the like) or feature other defining features or demarcations. The shaft provides rigid support for the light and control assemblies and allows the light fixture 100 to be inserted into the ground for proper placement.

Attached to the upper end of the post 4 is a composite lens assembly 20. The composite lens assembly 20 includes a transparent liner or sleeve 14 having a translucent mosaic covering 16 composed of a plurality of glass shards 17 affixed to an exterior surface 14a of the transparent liner or sleeve 14 and having a grout compound 18 infused in the interstices between the plurality of glass shards 17. The transparent liner or sleeve 14 is preferably constructed of a polymer (such as plastics or the like) or silica glass that is capable of transmitting light yet protecting the lighting components from the elements. The transparent liner 14 is a thin-walled cup having a shape that is symmetrical about its vertical axis and is open at one end.

For example, as shown in FIG. 2A the transparent liner 14 has a frusto-conical shape. Other embodiments may include a transparent liner having a cylindrical, parabolic, hemi-spherical shape or any combination thereof. While the liner or sleeve 14 is preferably transparent, other embodiments may be colored or frosted translucent to provide differing illumination effects. Additionally, while the exterior 14a and interior 14b surfaces of the transparent liner 14 are preferably smooth, in other embodiments they may be textured.

The composite lens assembly 20 is manufactured in a two-step process. First, a plurality of individual glass shards 17 are adhered to the outer or exterior surface 14a of the transparent liner 14. The glass shards 17 are preferably comprised of colored silica glass arranged in a decorative pattern. Nonetheless, by “glass” it is understood to include all frangible translucent polymer materials and the like. The individual glass shards may be geometrically shaped (i.e., triangular, square, circle, polygon) (e.g., 17a) or irregularly shaped (e.g., 17b). An adhesive substance is applied to a surface of each glass shard 17, which is then brought into contact with the exterior surface 14a of the transparent liner 14 forming an adhesive bond.

Once the exterior surface 14a of the transparent liner 14 is sufficiently covered with the plurality of glass shards 17, a grout compound 18 is infused into the interstices between the plurality of glass shards 17. While grout compound 18 is preferably a cementious compound, alternatively epoxy, urethane, and resin grout compounds may also be used. A heavy layer of the grout compound 18 is applied to the outer surface of the plurality of glass shards 17 covering liner 14. The grout compound 18 is then worked into the interstices between the plurality of glass shards 17 until the interstices are filled with grout compound 18 approximately up to the level of the glass shards 17. The grout compound 18 is then allowed to set or firm-up whereupon the exterior of the composite lens assembly 20 is wiped down with a cloth removing any grout residue from the plurality of glass shards 17 revealing a tiffany-style lens assembly.

A reflector element 46 may be configured on the interior of and near the closed bottom of the composite lens assembly 20 in order to assist in reflecting and directing the light towards the exterior of the composite lens assembly 20. As shown in FIG. 2A, in one embodiment the reflector element 46 is affixed to the composite lens assembly 20 by a screw fastener which accesses the reflector element 46 through a small hole drilled into the bottom of the transparent liner 14. In other embodiments, the reflector element 46 may simply be glued into position with an adhesive bonding agent.

The transparent liner 14 preferably includes an annular lip 21 extending outwardly from the circumferential rim 22 of the transparent liner 14. The annular lip 21 provides an abutment against which the glass shards 17 can be positioned. The annular lip 21 together with the circumferential rim 22 provides a smooth mating surface between the composite lens assembly 20 and the cap assembly 30, which houses the power and control assemblies.

The transparent liner 14 may also include a mechanism for rotatively attaching to a cap assembly 30, which houses the power and control assemblies. For example, as shown FIG. 2A the transparent liner 14 includes tabs 19 configured on and extending outwardly from the peripheral edge of the top or rim 22 of the transparent liner 14. The tabs 19 are of sufficient size that they extend past the finished surface of the translucent mosaic covering 16 of a finished composite lens assembly 20. The two tabs 19 are designed to rotatively engage complementary slots formed in the bottom surface 34 of the cap assembly 30. While not explicitly depicted, it is understood that the tabs 19 may be extended about the periphery so as to form a threaded screw, which rotatively engages complementary threads formed in the bottom surface 34 of the cap assembly 30. It is further understood that upper portion of the annular lip 21 may include screw threads formed therein that rotatively engage complementary threads formed in the bottom surface 34 of the cap assembly 30.

The transparent liner 14 may also include a stub fitting 12, extending from the closed or bottom portion of the transparent liner 14, for securely attaching the composite lens assembly 20 to the post 4. As shown in FIGS. 2A-B, in a preferred embodiment the peripheral shape of the stub fitting 12 is designed to snugly engage the inner circumference of the post 4. In other embodiments, the stub fitting 12 may include screw threads (either about its periphery or formed therein) for engaging complementary screw threads on the upper end of the post 4.

With referenced now to FIG. 2A, the outdoor lighting fixture 100 of the present invention also includes a cap assembly 30 that is removably attached to the circumferential rim 22 of the composite lens assembly 20. The cap assembly 30 houses the power and control assemblies of the present system. The cap assembly 30 includes a top or cover 32 fixed to a base or bottom surface 34. For example, in one embodiment threaded screw fasteners 31 extending through the base 34 through risers 37 and into the cover 32 are used to fixably attach the cover 32 to the base 34. The base 34 is located beneath the cover 32 and is shielded thereby.

The cap assembly 30 is designed so as to include a space between the cover 32 to the base 34 which houses the power and control assemblies. For example, as shown in FIG. 2A, a battery compartment 33 for housing a rechargeable battery is formed in the base 34. Electrical circuit components such a microprocessor configured on a printed circuit board 40 and one or more light emitting diodes (LEDs) 42 are positioned within the space between the cover 32 to the base 34. A solar panel or cell 36 configured on top of the cover 32 is used to covert sunlight into electrical current, which is stored in the rechargeable battery. Also, the electrical circuit typically includes a photocell 39 for determining the ambient light conditions. When the photocell 39 senses darkness, the electrical circuit supplies electricity from the battery to the LEDs in a conventional manner.

The LEDs 42 project through a hole formed in the base 34 out past the bottom surface of the base 34. The cap assembly 30 may also include a protective lens assembly 44 which surrounds the exposed ends of the LED 42 when attached to the base 34. Thus, when the cap assembly 30 is rotatively attached to the circumferential rim 22 of the composite lens assembly 20 the projecting LED 42 are configured within the interior of the composite lens assembly 20. When the LED 42 is energized the generated light is projected into the interior of the composite lens assembly 20 where it is reflected and refracted through the plurality of glass shards 17, which creates an enchanting lighting effect.

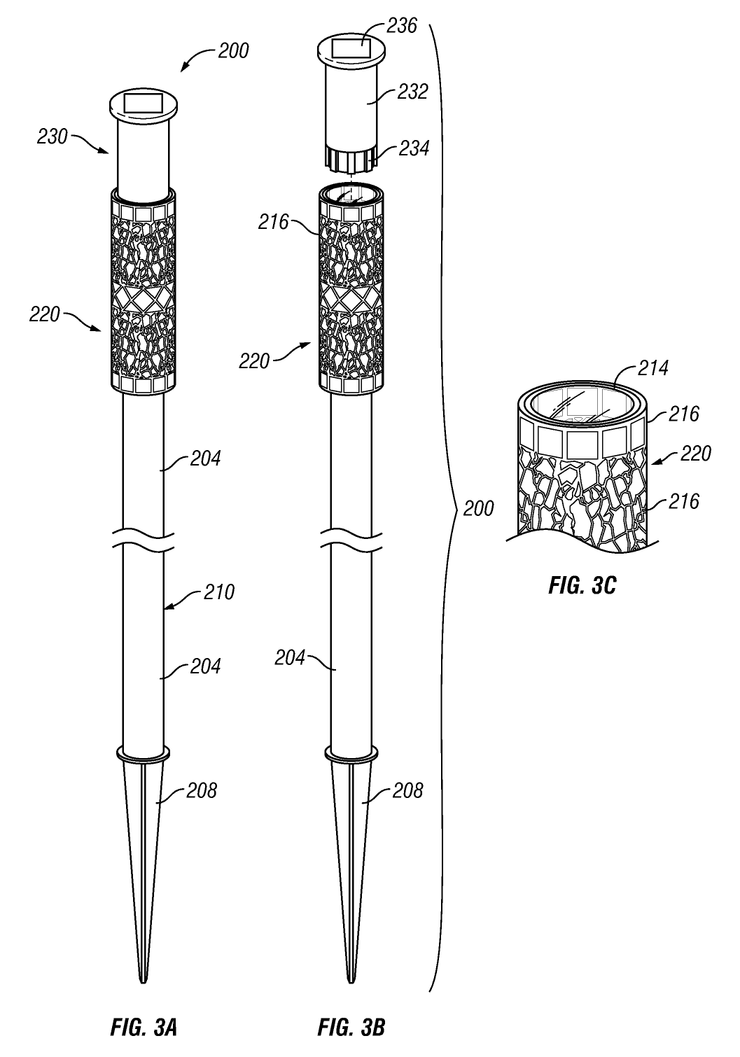

With reference now to FIGS. 3A-3C, a second embodiment of the present invention 200 is depicted. This embodiment 200 is also a solar powered outdoor lighting fixture as previously described that can be located and operated in any area that receives daytime exposure to sunlight. The light fixture 200 includes a body 210 comprising an extender assembly or post 204 on the lower end from which there extends a spike 208. The spike 208 is connected to the post 204 by means of a friction fit connector as previously described. The spike 208 is driven into a ground surface so that the post 204 is exposed above the ground surface.

Attached to the upper end of the post 207 is a cylindrically-shaped composite lens assembly 220 that is manufactured in accordance with the method previously described. The composite lens assembly 220 includes a cylindrically-shaped transparent liner or sleeve 14 as previously described having a translucent mosaic covering 216 composed of a plurality of glass shards having a grout compound infused in the interstices between the plurality of glass shards as previously described.

The outdoor lighting fixture 200 also includes a cap assembly 230 that is removably attached to the composite lens assembly 220. As previously described, the cap assembly 230 houses the power and control assemblies of the present system. However, in contrast to the previously described embodiment, the cap assembly 230 of this embodiment includes a connector fitting 234 extending from the bottom portion of the cap assembly 230 that for securely attaching the cap assembly 230 to the composite lens assembly 220. In a preferred embodiment, the peripheral shape of the connector fitting 234 is designed to snugly engage the inner circumference of the cylindrically-shaped transparent liner 214. In other embodiments, the connector fitting 234 may include screw threads (either about its periphery or formed therein) for engaging complementary screw threads on the upper end of the cylindrically-shaped transparent liner 214.

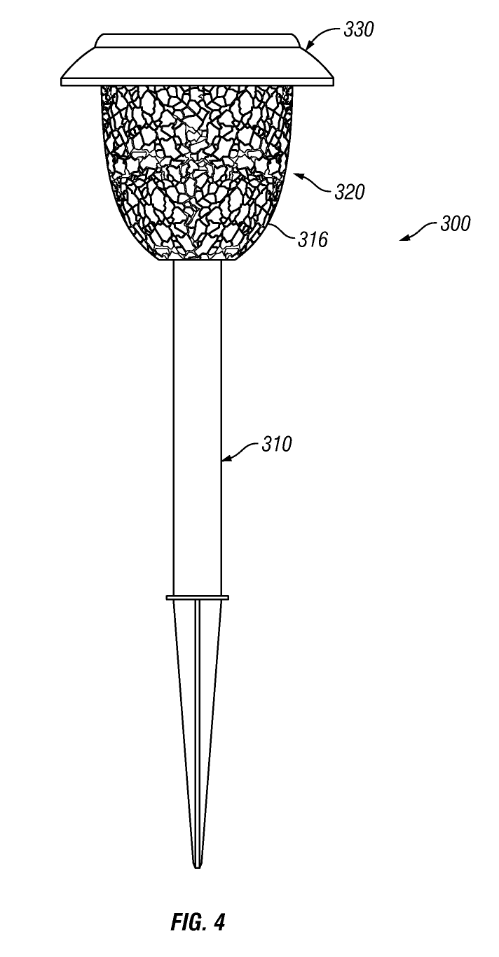

With reference now to FIG. 4, a third embodiment of the present invention 300 is depicted. This embodiment 300 is also a solar powered outdoor lighting fixture as previously described that can be located and operated in any area that receives daytime exposure to sunlight. The light fixture 300 includes a body 310 comprising an extender assembly or post on the lower end from which there extends a spike. The spike is connected to the post by means of a friction fit connector as previously described. The spike is driven into a ground surface so that the post is exposed above the ground surface.

Attached to the upper end of the post is a paraboloidal-shaped composite lens assembly 320 that is manufactured in accordance with the method previously described. The composite lens assembly 320 includes a paraboloidal-shaped transparent liner or sleeve 14 as previously described having a translucent mosaic covering 316 composed of a plurality of glass shards having a grout compound infused in the interstices between the plurality of glass shards as previously described. The outdoor lighting fixture 300 also includes a cap assembly 330 that is removably attached to the composite lens assembly 320. As previously described, the cap assembly 330 houses the power and control assemblies of the present system.

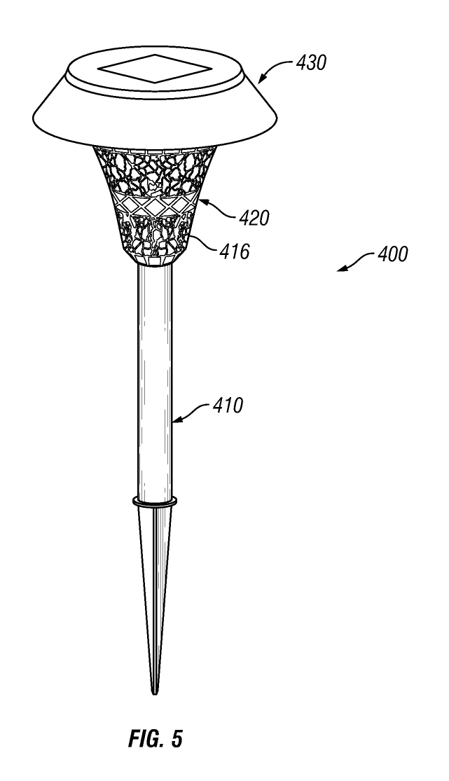

With reference now to FIG. 5, a fourth embodiment of the present invention 400 is depicted. This embodiment 400 is also a solar powered outdoor lighting fixture as previously described that can be located and operated in any area that receives daytime exposure to sunlight. The light fixture 400 includes a body 410 comprising an extender assembly or post on the lower end from which there extends a spike. The spike is connected to the post by means of a friction fit connector as previously described. The spike is driven into a ground surface so that the post is exposed above the ground surface.

Attached to the upper end of the post is a tulip-shaped composite lens assembly 420 that is manufactured in accordance with the method previously described. The composite lens assembly 420 includes a tulip-shaped transparent liner or sleeve 14 as previously described having a translucent mosaic covering 416 composed of a plurality of glass shards having a grout compound infused in the interstices between the plurality of glass shards as previously described. The outdoor lighting fixture 400 also includes a cap assembly 430 that is removably attached to the composite lens assembly 420. As previously described, the cap assembly 430 houses the power and control assemblies of the present system.

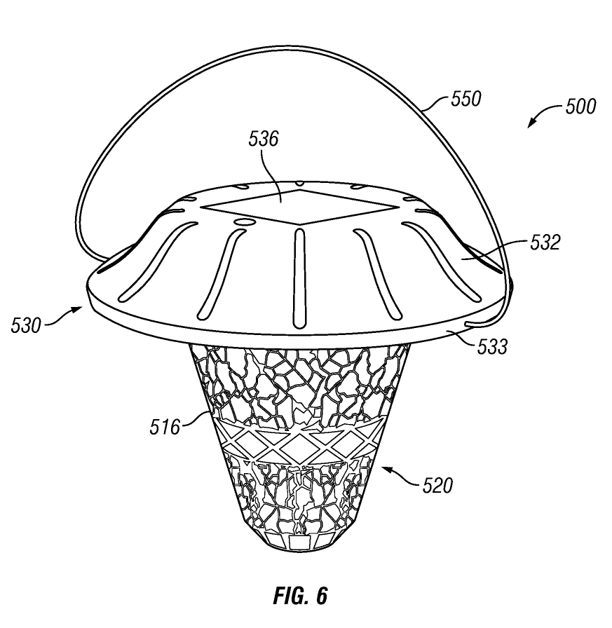

With reference now to FIG. 6, a fifth embodiment of the present invention 500 is depicted. This embodiment 500 is also a solar powered outdoor lighting fixture as previously described that can be located and operated in any area that receives daytime exposure to sunlight. In contrast to the previously described embodiments, this light fixture 500 is designed to be a hanging variant. Thus, the light fixture 500 depicted does not include a post or spike for attachment to the ground. Instead, the light fixture 500 comprises a composite lens assembly 520 removably attached to a cap assembly 530 that includes a hanging mechanism 550. The composite lens assembly 520 is manufactured in accordance with the method previously described. The composite lens assembly 520 includes a transparent liner or sleeve 14 as previously described having a translucent mosaic covering 516 composed of a plurality of glass shards having a grout compound infused in the interstices between the plurality of glass shards as previously described.

The outdoor lighting fixture 500 also includes a cap assembly 530 that is removably attached to the composite lens assembly 520. As previously described, the cap assembly 530 houses the power and control assemblies of the present system. In addition, cap assembly 530 also includes a hanging mechanism 550 which enables the outdoor lighting fixture 500 to be hung from a hook or other like device. For example, as shown in FIG. 6, in one embodiment the hanging mechanism 550 comprises a length of wire or cord having its two distal ends attached to a peripheral edge 533 of the cap assembly 530.

It will now be evident to those skilled in the art that there has been described herein an improved outdoor lighting fixture and method for making the same. Although the invention hereof has been described by way of a preferred embodiment, it will be evident that other adaptations and modifications can be employed without departing from the spirit and scope thereof. For example, standard and low-voltage outdoor light fixtures are also suitable for incorporation of composite lens assemblies as described and disclosed herein. The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. An outdoor lighting fixture comprising:
a composite lens assembly including a thin-walled liner having a shape that is symmetrical about its vertical axis and having an open rim at one end, wherein said thin-walled liner has an exterior surface covered with a translucent mosaic covering composed of a plurality of glass shards affixed to said exterior surface and having a grout compound infused into the interstices between the plurality of glass shards.

2. The outdoor lighting fixture of claim 1, wherein said thin-walled liner includes an annular lip extending outwardly from the perimeter of said rim.

3. The outdoor lighting fixture of claim 2, wherein said rim includes a mechanism for rotatively attaching to a cap assembly.

4. The outdoor lighting fixture of claim 3, wherein said mechanism comprises a tab extending outwardly from the peripheral edge of said rim.

5. The outdoor lighting fixture of claim 3, wherein said mechanism comprises screw threads formed in said annular lip.

6. The outdoor lighting fixture of claim 3, wherein said cap assembly has a hanging mechanism incorporated therein.

7. The outdoor lighting fixture of claim 6, wherein said hanging mechanism comprises a length of wire having two distal ends attached to a peripheral edge of the cap assembly.

8. The outdoor lighting fixture of claim 1, wherein said thin-walled liner includes a stub fitting extending from the bottom of said liner for attaching said composite lens assembly to a post.

9. The outdoor lighting fixture of claim 1, wherein said thin-walled liner is constructed of a polymer.

10. The outdoor lighting fixture of claim 1, wherein said thin-walled liner is constructed of silica glass.

11. The outdoor lighting fixture of claim 1, wherein said thin-walled liner is transparent.

12. The outdoor lighting fixture of claim 1, wherein said thin-walled liner is translucent.

13. The outdoor lighting fixture of claim 1, wherein said thin-walled liner is colored.

14. The outdoor lighting fixture of claim 1, wherein said shape of said thin-wall liner is frusto-conical.

15. The outdoor lighting fixture of claim 1, wherein said shape of said thin-wall liner is frusto-conical.

16. The outdoor lighting fixture of claim 1, wherein said shape of said thin-wall liner is cylindrical.

17. The outdoor lighting fixture of claim 1, wherein said shape of said thin-wall liner is paraboloidal.

18. The outdoor lighting fixture of claim 1, wherein said shape of said thin-wall liner is hemi-spherical.

19. A composite lens assembly for an outdoor lighting fixture made by a process comprising:
obtaining a thin-walled liner having a shape that is symmetrical about its vertical axis and having an open rim at one end,
covering an exterior surface of said liner by adhering a plurality of glass shards to said exterior surface; and
infusing a grout compound into the interstices between the plurality of glass shards until the interstices are substantially filled with grout compound.

20. The process of claim 19, further comprising:
allowing said grout compound to firm-up;
wiping exterior surface of said composite lens assembly to remove grout residue from plurality of glass shards.
